(19) United States
(12) Patent Application Publication
(10) Pub. No.: US 2024/0304900 A1
(43) Pub. Date: Sep. 12, 2024

(54) HEAT MANAGEMENT SYSTEM

(71) Applicant: Toyota Jidosha Kabushiki Kaisha, Toyota-shi (JP)

(72) Inventor: Tomoaki SUZUKI, Nagoya-shi (JP)

(73) Assignee: Toyota Jidosha Kabushiki Kaisha, Toyota-shi (JP)

(21) Appl. No.: 18/595,583

(22) Filed: Mar. 5, 2024

(30) Foreign Application Priority Data
Mar. 9, 2023 (JP) 2023-036650

(51) Int. Cl. H01M 10/663; B60H 1/00; B60H 1/32; B60K 1/00; B60K 11/08; H01M 10/615; H01M 10/625; H01M 10/63; H01M 10/6568

(52) U.S. Cl. CPC H01M 10/663; B60K 11/085; H01M 10/615; H01M 10/625; H01M 10/63; H01M 10/6568; B60H 1/00278; B60H 2001/00307; B60H 1/32284; B60K 2001/005; B60K 2001/006; H01M 2220/20

(57) ABSTRACT

A heat management system includes an electrical storage device configured to exchange heat with a first channel, a drive unit configured to exchange heat with a second channel, a radiator provided in a third channel, a chiller provided in a fourth channel, and a switching unit. The switching unit is configured to, when the electrical storage device is heated, isolate the first channel from the other channels, cause a circuit with which a heat medium circulates through the second channel and the third channel to be formed, and cause a circuit with which the heat medium circulates through only the fourth channel to be formed.

### CROSS-REFERENCE TO RELATED APPLICATION

This application claims priority to Japanese Patent Application No. 2023-036650 filed on Mar. 9, 2023, incorporated herein by reference in its entirety.

### BACKGROUND

### 1. Technical Field

The disclosure relates to a heat management system.

### 2. Description of Related Art

Japanese Unexamined Patent Application Publication No. 2010-272395 (JP 2010-272395 A) describes an electrified vehicle. The electrified vehicle includes an electrical storage device (battery), an inverter, a motor, and a controller. The electrical storage device is connected to the inverter. The inverter is connected to the motor. The controller controls the current of the electrical storage device by means of switching control of the inverter. Thus, the controller controls heat generated due to power losses in an internal resistance of the electrical storage device. Therefore, the controller is capable of executing heating control for increasing the temperature of the electrical storage device by using the current of the electrical storage device (self-heating of the electrical storage device).

### SUMMARY

In an electrical apparatus, such as an electrified vehicle, it is sometimes important to effectively use heat generated from a drive unit including an inverter and a motor. Furthermore, it is desired to efficiently heat an electrical storage device.

The disclosure provides a heat management system capable of achieving both effective use of heat generated from a drive unit and efficient heating of an electrical storage device.

An aspect of the disclosure provides a heat management system. The heat management system is provided in an electrical apparatus. The heat management system includes a first channel, a second channel, a third channel, and a fourth channel configured such that a heat medium flows through the first channel, the second channel, the third channel, and the fourth channel, an electrical storage device configured to exchange heat with the heat medium flowing through the first channel, a drive unit configured to exchange heat with the heat medium flowing through the second channel and supply driving force to the electrical apparatus, a radiator provided in the third channel, a chiller provided in the fourth channel, and a switching unit configured to switch a connection status among the first channel, the second channel, the third channel, and the fourth channel. The switching unit is configured to, when the electrical storage device is heated, isolate the first channel from the other channels, cause a circuit with which the heat medium circulates through the second channel and the third channel to be formed, and cause a circuit with which the heat medium circulates through only the fourth channel to be formed.

The heat management system according to the above aspect may further include a grille shutter configured to adjust a volume of air heading toward the radiator by adjusting an opening degree of the grille shutter. The grille shutter may be configured to, when the electrical storage device is heated, increase the opening degree when a temperature of the heat medium flowing through the second channel and the third channel or a temperature of the drive unit becomes higher than a prescribed temperature.

In the heat management system according to the above aspect, the switching unit may be a five-way valve or a six-way valve.

According to the aspect of the disclosure, it is possible to provide a heat management system capable of achieving both effective use of heat generated from the drive unit and efficient heating of the electrical storage device.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram that schematically shows an electrified vehicle equipped with a heat management system according to a first embodiment of the disclosure;

FIG. 2 is a block diagram that shows the configuration of the heat management system according to the first embodiment;

FIG. 3 is a block diagram that shows the configuration of a heat management circuit of the heat management system;

FIG. 4 is a block diagram that schematically shows an isolation mode of the heat management circuit when a battery is heated;

FIG. 5 is a flowchart that shows the control details of the heat management system;

FIG. 6 is a flowchart that shows a modification of the control details of the heat management system;

FIG. 7 is a block diagram that shows the configuration of a heat management system according to a second embodiment of the disclosure;

FIG. 8 is a block diagram that shows the configuration of a heat management circuit of the heat management system;

FIG. 9 is a diagram that schematically shows an isolation mode of the heat management circuit when a battery is heated;

FIG. 10 is a block diagram that shows the configuration of a heat management circuit according to a third embodiment of the disclosure; and

FIG. 11 is a block diagram that shows a circuit configuration including a battery, a converter, an inverter, and a motor.

### DETAILED DESCRIPTION OF EMBODIMENTS

Hereinafter, a first embodiment of the disclosure will be described in detail with reference to the accompanying drawings. Like reference signs denote the same or corresponding portions in the drawings, and the description thereof will not be repeated.

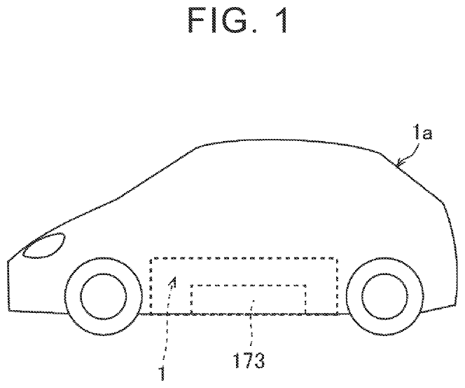

Hereinafter, a configuration in which the heat management system according to the aspect of the disclosure is mounted on an electrified vehicle 1a (see FIG. 1) will be described as an example. The electrified vehicle 1a is preferably a vehicle equipped with a drive battery 173 and is, for example, a battery electric vehicle (BEV). The electrified vehicle 1a may be a hybrid electric vehicle (HEV), a plug-in hybrid electric vehicle (PHEV), or a fuel cell electric vehicle (FCEV). However, the uses of the heat management system according to the aspect of the disclosure are not limited to heat management systems for vehicles. The electrified vehicle 1a is an example of the electrical apparatus according to the aspect of the disclosure.

### First Embodiment

### Overall Configuration

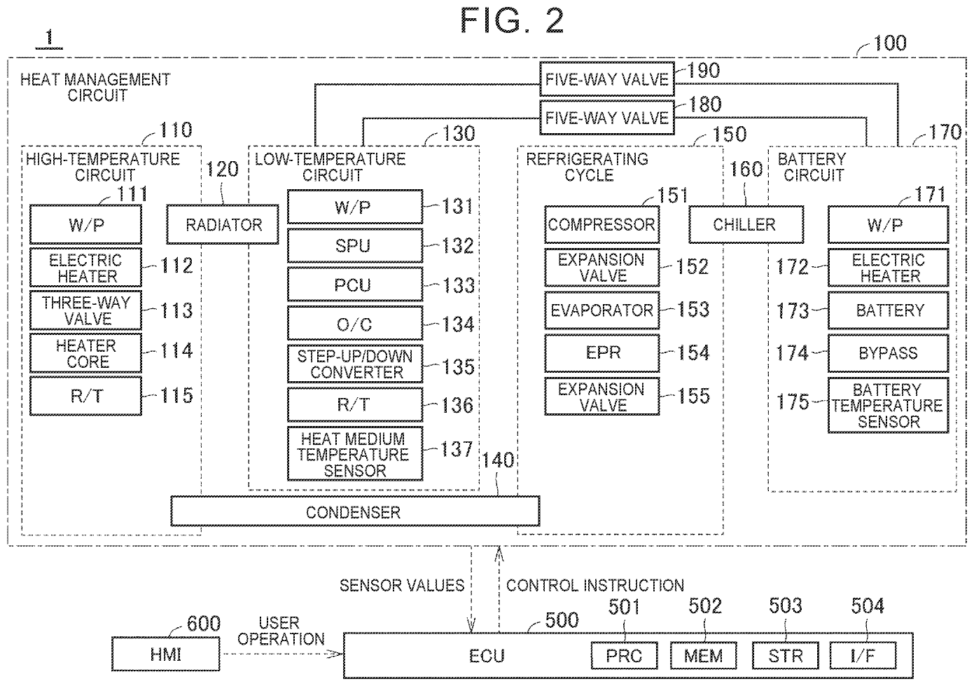

FIG. 2 is a block diagram that shows an example of the overall configuration of a heat management system 1 according to the first embodiment of the disclosure. The heat management system 1 includes a heat management circuit 100, an electronic control unit (ECU) 500, and a human machine interface (HMI) 600. The ECU 500 is an example of the controller according to the aspect of the disclosure.

The heat management circuit 100 is configured such that a medium (such as water) that exchanges heat flows through the heat management circuit 100. As shown in FIG. 2, the heat management circuit 100 includes, for example, a high-temperature circuit 110, a radiator 120, a low-temperature circuit 130, a condenser 140, a refrigerating cycle 150, a chiller 160, a battery circuit 170, a five-way valve 180, and a five-way valve 190. Each of the five-way valve 180 and the five-way valve 190 is an example of the switching unit according to the aspect of the disclosure.

The high-temperature circuit 110 includes, for example, a water pump (W/P) 111, an electric heater 112, a three-way valve 113, a heater core 114, a reservoir tank (R/T) 115, and a heat medium (such as water) (not shown).

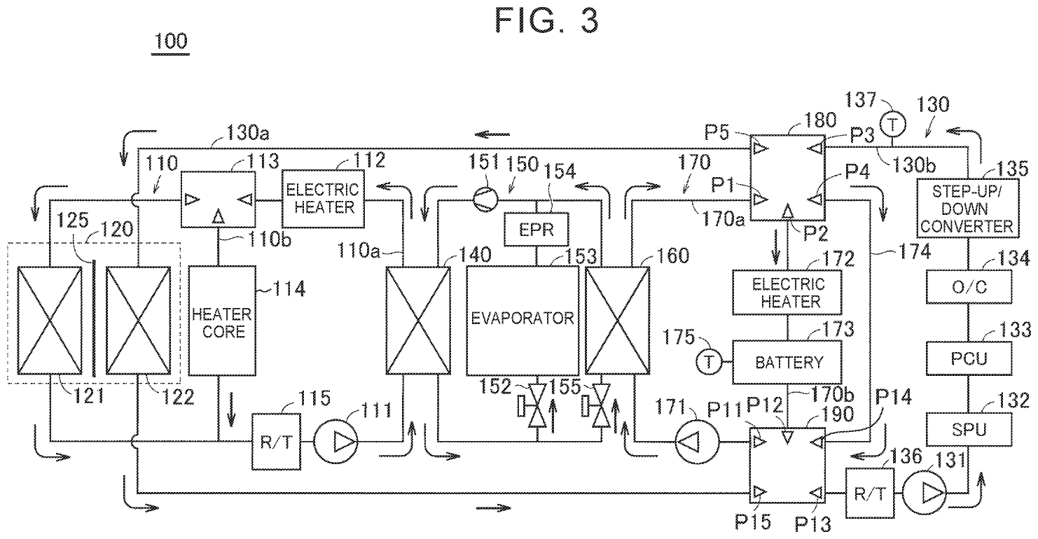

The radiator 120 is connected to (that is, shared between) both the high-temperature circuit 110 and the low-temperature circuit 130. The radiator 120 includes a high-temperature (HT) radiator 121 (see FIG. 3) and a low-temperature (LT) radiator 122 (see FIG. 3). The low-temperature radiator 122 is an example of the radiator according to the aspect of the disclosure.

The low-temperature circuit 130 includes, for example, a water pump 131, a smart power unit (SPU) 132, a power control unit (PCU) 133, an oil cooler (O/C) 134, a step-up/down converter 135, a reservoir tank 136, a heat medium temperature sensor 137, and a heat medium (such as water) (not shown). The PCU 133 and the oil cooler 134 are an example of the drive unit according to the aspect of the disclosure.

The condenser 140 is connected to both the high-temperature circuit 110 and the refrigerating cycle 150.

The refrigerating cycle 150 includes, for example, a compressor 151, an expansion valve 152, an evaporator 153, an evaporative pressure regulator (EPR) 154, an expansion valve 155, and a working medium (such as water and a medium having a lower boiling point than water) (not shown).

The chiller 160 is connected to both the refrigerating cycle 150 and the battery circuit 170.

The battery circuit 170 includes, for example, a water pump 171, an electric heater 172, the battery 173, a bypass route 174, and a battery temperature sensor 175. The water pump 171 is an example of the pump according to the aspect of the disclosure, and the battery 173 is an example of the electrical storage device according to the aspect of the disclosure.

Each of the five-way valve 180 and the five-way valve 190 is connected to the low-temperature circuit 130 and the battery circuit 170. The configuration of the heat management circuit 100 will be described in detail with reference to FIG. 3.

The ECU 500 controls the heat management circuit 100. The ECU 500 includes a processor 501, a memory 502, a storage 503, and an interface 504.

The processor 501 is, for example, a central processing unit (CPU) or a micro-processing unit (MPU). The memory 502 is, for example, a random access memory (RAM). The storage 503 is a rewritable nonvolatile memory, such as a hard disk drive (HDD), a solid state drive (SSD), and a flash memory. A system program including an operating system (OS) and a control program including computer-readable code needed for control operations are stored in the storage 503. The processor 501 implements various processes by reading the system program and the control program, expanding the system program and the control program on the memory 502, and running the system program and the control program. The interface 504 controls communication between the ECU 500 and components of the heat management circuit 100.

The ECU 500 generates a control instruction based on sensor values acquired from various sensors (for example, the battery temperature sensor 175 and the heat medium temperature sensor 137) included in the heat management circuit 100, a user operation accepted by the HMI 600, and the like, and outputs the generated control instruction to the heat management circuit 100. The ECU 500 may be divided into a plurality of ECUs function by function. FIG. 2 shows an example in which the ECU 500 includes the single processor 501. Alternatively, the ECU 500 may include multiple processors. The same applies to the memory 502 and the storage 503.

In the specification, the term “processor” is not limited to a narrow-sense processor that executes a process in a stored program manner and can include a hard wired circuit, such as an application specific integrated circuit (ASIC) and a field-programmable gate array (FPGA). For this reason, the term “processor” may be read as processing circuitry in which a process is defined in advance by a computer-readable code and/or a hard wired circuit.

The HMI 600 is a touch panel display, an operation panel, a console, or the like. The HMI 600 accepts a user operation for controlling the heat management system 1. The HMI 600 outputs a signal indicating a user operation to the ECU 500.

### Configuration of Heat Management Circuit

FIG. 3 is a block diagram that shows an example of the configuration of the heat management circuit 100 according to the first embodiment. As shown in FIG. 3, the high-temperature circuit 110 includes a channel 110a and a channel 110b. The channel 110a connects the water pump 111, the condenser 140, the electric heater 112, the three-way valve 113, the high-temperature radiator 121, the reservoir tank 115, and the water pump 111 in this order. The channel 110b connects the three-way valve 113, the heater core 114, and the reservoir tank 115 in this order.

A heat medium (such as water) in the high-temperature circuit 110 flows along at least one of a first route and a second route. In the first route, the heat medium circulates in order of the water pump 111, the condenser 140, the electric heater 112, the three-way valve 113, the heater core 114, the reservoir tank 115, and the water pump 111. In the second route, the heat medium circulates in order of the water pump 111, the condenser 140, the electric heater 112, the three-way valve 113, the high-temperature radiator 121, the reservoir tank 115, and the water pump 111. The three-way valve 113 switches the route of flow of the heat medium such that the heat medium flows through at least one of the first route and the second route.

The water pump 111 circulates the heat medium in the high-temperature circuit 110 in accordance with a control instruction from the ECU 500. The condenser 140 exchanges heat between the heat medium and a working medium in the refrigerating cycle 150. The electric heater 112 heats the heat medium. The heater core 114 heats air, supplied to a vehicle cabin (not shown) in the electrified vehicle 1a, with the heat medium. The reservoir tank 115 maintains the pressure and amount of heat medium in the high-temperature circuit 110 by storing part of the heat medium in the high-temperature circuit 110.

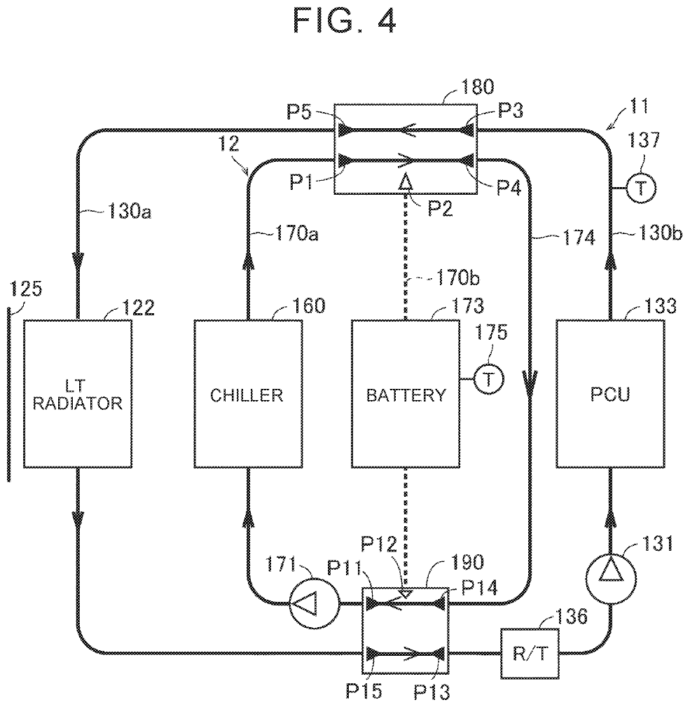

As shown in FIG. 3 and FIG. 4, the low-temperature circuit 130 includes a channel 130a and a channel 130b. The channel 130a connects the five-way valve 180, the low-temperature radiator 122, and the five-way valve 190 in this order. The channel 130b connects the five-way valve 190, the reservoir tank 136, the water pump 131, the SPU 132, the PCU 133, the oil cooler 134, the step-up/down converter 135, and the five-way valve 180 in this order. The channel 130b is in thermal contact with the SPU 132, the PCU 133, the oil cooler 134, and the step-up/down converter 135. The channel 130a is an example of the third channel according to the aspect of the disclosure, and the channel 130b is an example of the second channel according to the aspect of the disclosure.

A heat medium (such as water) in the low-temperature circuit 130 flows to circulate along the route passing the water pump 131, the SPU 132, the PCU 133, the oil cooler 134, the step-up/down converter 135, the five-way valve 180, the low-temperature radiator 122, the five-way valve 190, the reservoir tank 136, and the water pump 131 in this order.

The water pump 131 circulates the heat medium in the low-temperature circuit 130 in accordance with a control instruction from the ECU 500. The SPU 132 controls charging and discharging of the battery 173 in accordance with a control instruction from the ECU 500. The PCU 133 converts direct-current power, supplied from the battery 173, to alternating-current power and supplies the alternating-current power to a motor (not shown) incorporated in a transaxle in accordance with a control instruction from the ECU 500. The oil cooler 134 circulates lubricating oil of the motor by using an electrical oil pump (EOP) (not shown). The oil cooler 134 cools the transaxle by heat exchange between the heat medium circulating in the low-temperature circuit 130 and the lubricating oil of the motor. The SPU 132, the PCU 133, the oil cooler 134, and the step-up/down converter 135 are cooled by the heat medium that circulates in the low-temperature circuit 130. The reservoir tank 136 maintains the pressure and amount of heat medium in the low-temperature circuit 130 by storing part of the heat medium in the low-temperature circuit 130. The heat medium temperature sensor 137 detects the temperature of heat medium flowing in the low-temperature circuit 130. The heat medium temperature sensor 137, for example, detects the temperature of heat medium flowing out from the step-up/down converter 135. Each of the five-way valve 180 and the five-way valve 190 switches the route of heat medium in the low-temperature circuit 130 and the battery circuit 170 in accordance with a control instruction from the ECU 500. The low-temperature radiator 122 is disposed near the high-temperature radiator 121. A heat medium flowing in the low-temperature radiator 122 exchanges heat with a heat medium flowing in the high-temperature radiator 121. The heat management system 1 includes a grille shutter 125 disposed near the low-temperature radiator 122. The grille shutter 125 is capable of adjusting the volume of air heading toward the low-temperature radiator 122 by adjusting the opening degree in accordance with a control instruction from the ECU 500. Instead of the oil cooler 134, the transaxle may be provided in the low-temperature circuit 130.

A working medium in the refrigerating cycle 150 flows along at least one a first route and a second route. In the first route, the working medium circulates in order of the compressor 151, the condenser 140, the expansion valve 152, the evaporator 153, the EPR 154, and the compressor 151. In the second route, the working medium circulates in order of the compressor 151, the condenser 140, the expansion valve 155, the chiller 160, and the compressor 151. The expansion valve 152 and the expansion valve 155 switch the route of flow of working medium such that the working medium flows along at least one of the first route and the second route.

The compressor 151 compresses gas working medium flowing out from the chiller 160. The condenser 140 condenses a working medium by exchanging heat between the gas working medium discharged from the compressor 151 and a heat medium flowing in the high-temperature circuit 110. The expansion valve 152 and the expansion valve 155 expand a working medium flowing out from the condenser 140. The evaporator 153 evaporates a working medium by exchanging heat between the working medium flowing out from the expansion valve 152 and air supplied to the vehicle cabin in the electrified vehicle 1a. The evaporative pressure regulator 154 adjusts the pressure of working medium flowing out from the evaporator 153.

As shown in FIG. 3 and FIG. 4, the battery circuit 170 includes a channel 170a and a channel 170b. The channel 170a connects the five-way valve 190, the water pump 171, the chiller 160, and the five-way valve 180 in this order. The channel 170b connects the five-way valve 180, the electric heater 172, the battery 173, and the five-way valve 190 in this order. The channel 170b is thermally connected to the battery 173. The channel 170a is an example of the fourth channel according to the aspect of the disclosure, and the channel 170b is an example of the first channel according to the aspect of the disclosure.

A heat medium in the battery circuit 170 (the same heat medium as the heat medium flowing in the low-temperature circuit 130) flows along at least one of a first route and a second route. In the first route, the heat medium circulates in order of the water pump 171, the chiller 160, the five-way valve 180, the electric heater 172, the battery 173, the five-way valve 190, and the water pump 171. In the second route, the heat medium circulates in order of the water pump 171, the chiller 160, the five-way valve 180, the bypass route 174, the five-way valve 190, and the water pump 171. The five-way valve 180 and the five-way valve 190 switch between the first route and the second route such that the heat medium flows along at least one of the first route and the second route.

The water pump 171 circulates the heat medium in the battery circuit 170 in accordance with a control instruction from the ECU 500. The chiller 160 cools the heat medium circulating in the battery circuit 170 by exchanging heat between the working medium circulating in the refrigerating cycle 150 and the heat medium circulating in the battery circuit 170. The electric heater 172 heats a heat medium in accordance with a control instruction from the ECU 500. The battery 173 supplies driving electric power to the motor incorporated in the transaxle. The battery 173 is capable of being driven such that the temperature of the battery 173 increases. This control (hereinafter, referred to as heating control) is executed by the ECU 500. The battery 173 can be heated with the electric heater 172 or cooled with the chiller 160. The bypass route 174 connects the five-way valve 180 and the five-way valve 190 to each other such that the heat medium bypasses the electric heater 172 and the battery 173. When the heat medium flows along the bypass route 174, a temperature change in heat medium resulting from heat absorption or heat radiation between the heat medium and the battery 173 is reduced. The battery temperature sensor 175 detects the temperature of the battery 173.

The five-way valve 180 has five ports P1, P2, P3, P4, P5. The port P1 is an inlet port to which a heat medium flows in from the chiller 160. The port P2 is an outlet port from which a heat medium flows out toward the electric heater 172 and battery 173 of the battery circuit 170. The port P3 is an inlet port to which a heat medium passing through the SPU 132, PCU 133, oil cooler 134, and step-up/down converter 135 of the low-temperature circuit 130 flows in. The port P4 is an outlet port from which a heat medium flows out toward the bypass route 174 of the battery circuit 170. The port P5 is an outlet port from which a heat medium flows out toward the low-temperature radiator 122.

The five-way valve 190 has five ports P11, P12, P13, P14, P15. The port P11 is an outlet port from which a heat medium flows out toward the chiller 160. The port P12 is an inlet port to which a heat medium passing through the electric heater 172 and battery 173 of the battery circuit 170 flows in. The port P13 is an outlet port from which a heat medium flows out toward the SPU 132, PCU 133, oil cooler 134, and step-up/down converter 135 of the low-temperature circuit 130. The port P14 is an inlet port to which a heat medium flows in from the bypass route 174 of the battery circuit 170. The port P15 is an inlet port to which a heat medium flows in from the low-temperature radiator 122.

### Modes

FIG. 4 is a conceptual view that shows the outline of a predetermined mode (hereinafter, which may be referred to as isolation mode) in the heat management circuit 100, established by controlling the five-way valve 180 and the five-way valve 190. Through control of the five-way valve 180 and the five-way valve 190, a connection status among the channels 130a, 130b, 170a, 170b and bypass route 174 is switched. Thus, the heat management circuit 100 is switched between a plurality of modes including the isolation mode.

Here, since some electrified vehicles are not equipped with an engine, it may be not possible to heat a heating target of an electrified vehicle by using engine exhaust heat. Therefore, it may be important to effectively use heat generated from a drive unit including an inverter and a motor. Furthermore, it is desired to efficiently heat an electrical storage device by itself. In other words, it is desired to effectively heat an electrical storage device by itself while making it possible to effectively use heat generated from a drive unit.

Therefore, in the first embodiment, when the battery 173 is heated, the ECU 500 controls the five-way valve 180 and the five-way valve 190 such that the isolation mode shown in FIG. 4 is established. Specifically, in the isolation mode, a route that communicates the port P1 with the port P4 and a route that communicates the port P3 with the port P5 are established by the five-way valve 180, and a route that communicates the port P11 with the port P14 and a route that communicates the port P13 with the port P15 are established by the five-way valve 190.

As a result, a first closed circuit 11 (see FIG. 4) in which the channel 130b corresponding to the second channel and the channel 130a corresponding to the third channel are connected, a second closed circuit 12 (see FIG. 4) in which the channel 170a corresponding to the fourth channel and the bypass route 174 are connected are established, and the channel 170b corresponding to the first channel is isolated from the other channels. In other words, the battery 173 is in a state of being isolated from the other circuits (independent state). In this state, the ECU 500 places the grille shutter 125 in a closed state.

In the isolation mode shown in FIG. 4, during heating control of the ECU 500, that is, during self-heating for the battery 173 to increase the temperature of the battery 173, cooling of the battery 173 with a heat medium flowing through the first closed circuit 11 or the second closed circuit 12 is suppressed, and heat generated from the PCU 133 or the transaxle (not shown) is accumulated in the heat medium flowing through the first closed circuit 11.

As a result of these, it is possible to achieve both effective use of heat generated from the drive unit such as the PCU 133 and efficient self-heating of the battery 173.

During heating control of the battery 173 in the isolation mode, the ECU 500 increases the opening degree of the grille shutter 125 when the temperature of heat medium circulating in the first closed circuit 11 (a detected value of the heat medium temperature sensor 137) becomes higher than a prescribed temperature Tc. The prescribed temperature Tc is set to, for example, about 65° C.

As a result, the heat medium flowing in the first closed circuit 11 is cooled by the low-temperature radiator 122, so the drive unit such as the PCU 133 is effectively cooled.

### Control Method for Heat Management Circuit

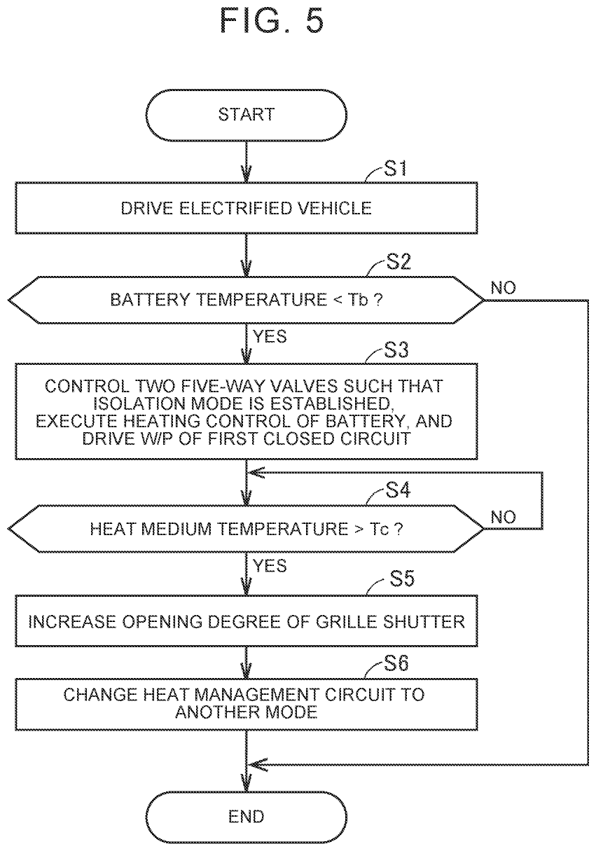

Next, a control method for the heat management system 1 will be described with reference to a flowchart shown in FIG. 5. The flow shown in FIG. 5 is only illustrative, and control details in the aspect of the disclosure are not limited to the example shown in FIG. 5.

Initially, the ECU 500 drives the electrified vehicle 1a (starts up a driving system) (step S1). Specifically, when a start button (not shown) of the electrified vehicle 1a is pressed, the PCU 133 and the battery 173 are electrically connected (by an SMR (not shown)). The ECU 500 detects that the electrified vehicle 1a is driven, when the ECU 500 receives a predetermined internal signal in the electrified vehicle 1a.

The ECU 500 determines whether the temperature of the battery 173 (a detected value of the battery temperature sensor 175) is lower than a reference temperature Tb[° C.] (step S2). The reference temperature Tb may be set to, for example, 10° C.

When the temperature of the battery 173 is higher than or equal to the reference temperature Tb (No in S2), the ECU 500 ends control. On the other hand, when the temperature of the battery 173 is lower than the reference temperature Tb (Yes in S2), the ECU 500 controls the five-way valve 180 and the five-way valve 190 such that the heat management circuit 100 is in the isolation mode shown in FIG. 4, executes heating control of the battery 173, and drives the water pump 131 of the first closed circuit 11 (step S3).

Subsequently, the ECU 500 determines whether the temperature of heat medium flowing in the first closed circuit 11 (a detected value of the heat medium temperature sensor 137) is higher than a prescribed temperature Tc (step S4). As a result, when the temperature of the heat medium is lower than or equal to the prescribed temperature Tc (No in S4), the ECU 500 returns to step S4 again.

On the other hand, when the temperature of the heat medium is higher than the prescribed temperature Tc (Yes in S4), the ECU 500 increases the opening degree of the grille shutter 125 (step S5). Thus, the heat medium flowing in the first closed circuit 11 is cooled by the low-temperature radiator 122, so the drive unit such as the PCU 133 is effectively cooled.

After that, the ECU 500 controls the five-way valve 180 and the five-way valve 190 such that the heat management circuit 100 is in another mode different from the isolation mode (step S6).

As described above, in the heat management system 1 according to the first embodiment, during heating control of the battery 173, the ECU 500 controls the five-way valve 180 and the five-way valve 190 such that the first closed circuit 11 in which the channel 130b and the channel 130a are connected and the second closed circuit 12 in which the channel 170a and the bypass route 174 are connected are formed and the channel 170b is isolated from the other channels. Therefore, during self-heating of the battery 173, cooling of the battery 173 with a heat medium flowing in the first closed circuit 11 or the second closed circuit 12 is suppressed. Since the grille shutter 125 is closed, heat generated from the PCU 133 or the transaxle (not shown) is effectively accumulated in a heat medium flowing in the first closed circuit 11. Thus, it is possible to achieve both effective use of heat generated from the drive unit such as the PCU 133 and efficient self-heating of the battery 173.

In the first embodiment, an example in which, when the battery 173 is heated, the ECU 500 controls the five-way valve 180 and the five-way valve 190 such that the isolation mode is established has been described; however, timing at which connection statuses of the five-way valve 180 and five-way valve 190 are switched such that the isolation mode is established is not limited to the above timing.

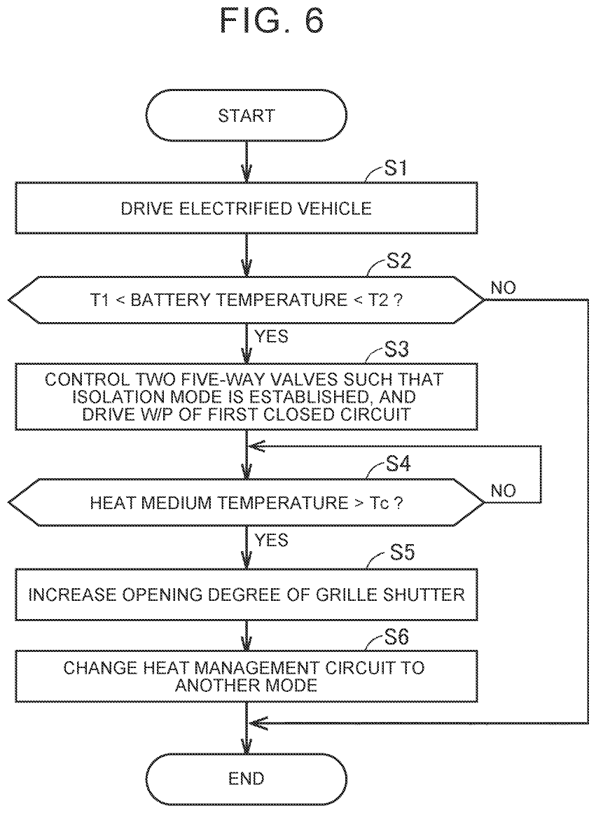

For example, when the temperature of the battery 173 is higher than a first set temperature T1 and lower than a second set temperature T2 higher than the first set temperature T1, the ECU 500 may control the five-way valve 180 and the five-way valve 190 such that the isolation mode is established. FIG. 6 shows a flowchart in this case. The flowchart differs from the flowchart shown in FIG. 5 only in step S2 and step S3. In other words, as shown in FIG. 6, when the temperature of the battery 173 is higher than the first set temperature T1 and lower than the second set temperature T2 (Yes in step S2), the ECU 500 controls the five-way valve 180 and the five-way valve 190 such that the heat management circuit 100 is in the isolation mode shown in FIG. 4 and drives the water pump 131 of the first closed circuit 11 (step S3). The first set temperature T1 is a temperature higher than the reference temperature Tb. The first set temperature T1 and the second set temperature T2 each are set so as to fall within a range in which the performance of the battery 173 is sufficiently exercised.

In the first embodiment, a heat exchanger may be provided in the second closed circuit 12 (for example, the bypass route 174), and a heat medium flowing in the second closed circuit 12 may be configured to be heated in the heat exchanger. In this case, when a heating request is issued after the electrified vehicle 1a is driven (after step S1), the ECU 500 may drive the compressor 151 and the water pump 111. Then, heat that the heat medium obtains in the heat exchanger provided in the bypass route 174 is supplied to the refrigerating cycle 150 via the chiller 160, so electric power consumed by the compressor 151, required to generate heat supplied from the refrigerating cycle 150 to the heater core 114 of the high-temperature circuit 110 via the condenser 140, is reduced.

### Second Embodiment

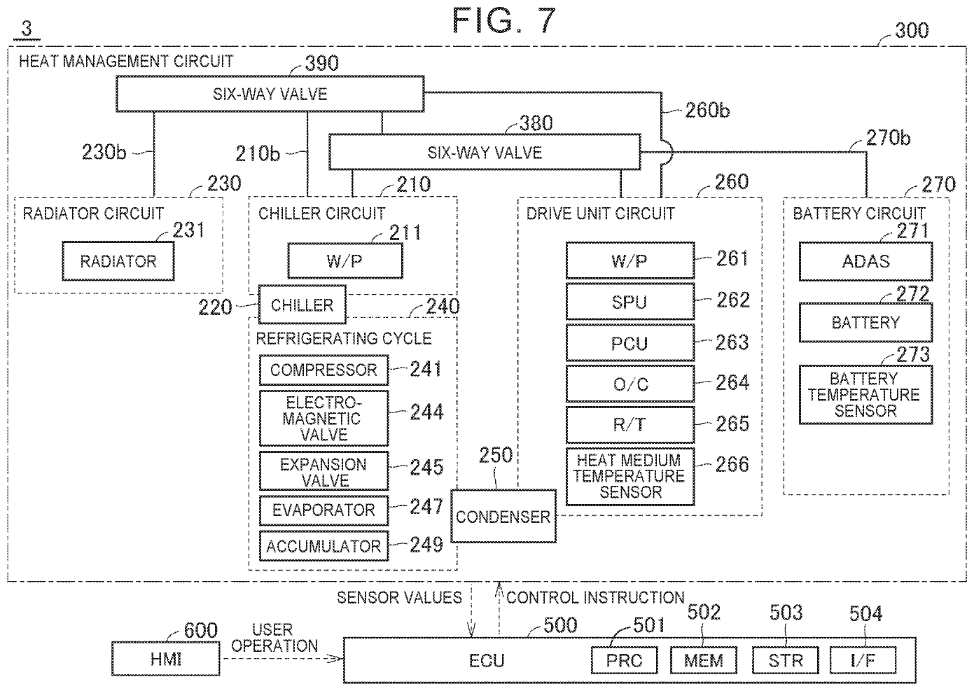

Next, a heat management circuit 300 according to a second embodiment of the disclosure will be described with reference to FIG. 7 to FIG. 9. In the second embodiment, only a portion different from the first embodiment will be described, and the description of the same structures, operations, and advantageous effects as those of the first embodiment will not be repeated.

### Overall Configuration

FIG. 7 is a block diagram that shows the configuration of a heat management system according to the second embodiment of the disclosure. A heat management system 3 differs from the heat management system 1 (see FIG. 1) according to the first embodiment in that the heat management circuit 300 is provided instead of the heat management circuit 100.

### Configuration of Heat Management Circuit

The heat management circuit 300 includes, for example, a chiller circuit 210, a chiller 220, a radiator circuit 230, a refrigerating cycle 240, a condenser 250, a drive unit circuit 260, a battery circuit 270, a six-way valve 380, and a six-way valve 390. The six-way valve 380 and the six-way valve 390 are an example of the switching unit according to the aspect of the disclosure.

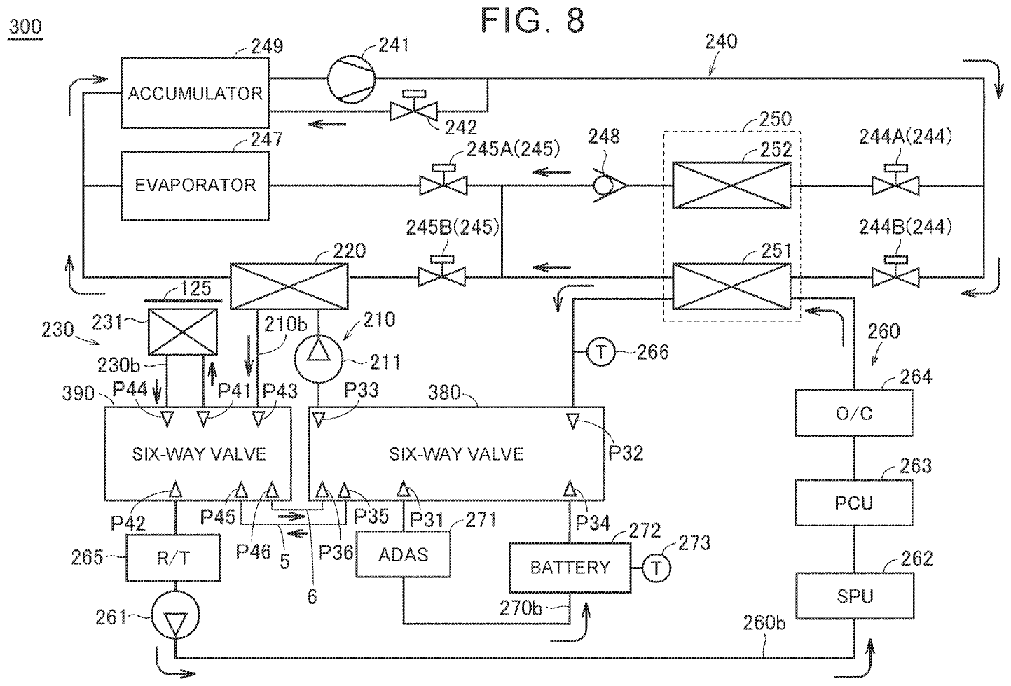

As shown in FIG. 8, the six-way valve 380 includes six ports P31, P32, P33, P34, P35, P36, and the six-way valve 390 includes six ports P41, P42, P43, P44, P45, P46. The six-way valve 380 is connected to the six-way valve 390. Specifically, the port P35 of the six-way valve 380 and the port P45 of the six-way valve 390 are connected by a coupling channel 5, and the port P36 of the six-way valve 380 and the port P46 of the six-way valve 390 are connected by a coupling channel 6. The coupling channel 5 and the coupling channel 6 are an example of the switching unit according to the aspect of the disclosure.

The chiller circuit 210 includes a water pump (W/P) 211 and a channel 210b. The channel 210b connects the six-way valve 380 (port P33), the water pump 211, the chiller 220, and the six-way valve 390 (port P43) in this order. The water pump 211 is an example of the pump according to the aspect of the disclosure, and the channel 210b is an example of the fourth channel according to the aspect of the disclosure.

The chiller 220 is connected to (shared between) both the chiller circuit 210 and the refrigerating cycle 240. The chiller 220 exchanges heat between a heat medium circulating in the chiller circuit 210 and a working medium circulating in the refrigerating cycle 240.

The radiator circuit 230 includes a radiator 231 and a channel 230b. The channel 230b connects the six-way valve 390 (port P41), the radiator 231, and the six-way valve 390 (port P44) in this order. The radiator 231 exchanges heat between a heat medium flowing in the radiator circuit 230 and air outside the vehicle. The channel 230b is an example of the third channel according to the aspect of the disclosure.

The refrigerating cycle 240 includes, for example, a compressor 241, electromagnetic valves 244 (244A, 244B), expansion valves 245 (245A, 245B), an evaporator 247, and an accumulator 249.

As shown in FIG. 8, the electromagnetic valve 244 includes a first electromagnetic valve 244A and a second electromagnetic valve 244B. The expansion valves 245 include the first expansion valve 245A and the second expansion valve 245B. Each of the electromagnetic valves 244A, 244B and the expansion valves 245A, 245B is capable of adjusting its opening degree.

As shown in FIG. 8, the condenser 250 includes a water-cooled condenser 251 and an air-cooled condenser 252. The water-cooled condenser 251 is connected to both the refrigerating cycle 240 and the drive unit circuit 260. The water-cooled condenser 251 exchanges heat between a gas working medium discharged from the compressor 241 and a heat medium flowing in the drive unit circuit 260.

In the example shown in FIG. 8, the refrigerating cycle 240 includes an electromagnetic valve 242. The electromagnetic valve 242 is connected in parallel with the compressor 241. The electromagnetic valve 242 adjusts the flow rate of working medium to be returned to the accumulator 249, of a working medium discharged from the compressor 241, in accordance with a control instruction from the ECU 500.

A working medium in the refrigerating cycle 240 flows along any one of the first route, the second route, the third route, and the fourth route.

The first route is a route that circulates in order of the compressor 241, the first electromagnetic valve 244A, the air-cooled condenser 252, a check valve 248, the first expansion valve (electromagnetic valve) 245A, the evaporator 247, the accumulator 249, and the compressor 241.

The second route is a route that circulates in order of the compressor 241, the first electromagnetic valve 244A, the air-cooled condenser 252, the check valve 248, the second expansion valve (electromagnetic valve) 245B, the chiller 220, the accumulator 249, and the compressor 241.

The third route is a route that circulates in order of the compressor 241, the second electromagnetic valve 244B, the water-cooled condenser 251, the first expansion valve 245A, the evaporator 247, the accumulator 249, and the compressor 241.

The fourth route is a route that circulates in order of the compressor 241, the second electromagnetic valve 244B, the water-cooled condenser 251, the second expansion valve 245B, the chiller 220, the accumulator 249, and the compressor 241.

The electromagnetic valves 244A, 244B and the expansion valves 245A, 245B switch the route among the first route, the second route, the third route, and the fourth route such that the working medium flows along any one of the first route, the second route, the third route, and the fourth route.

The accumulator 249 is to remove a liquid working medium from a working medium in a gas-liquid mixed state. When the liquid working medium does not completely evaporate in the evaporator 247, the accumulator 249 suppresses flow of a liquid working medium into the compressor 241.

The drive unit circuit 260 includes, for example, a water pump 261, an SPU 262, a PCU 263, an oil cooler 264, a reservoir tank 265, and a channel 260b. The channel 260b connects the six-way valve 390 (port P42), the reservoir tank 265, the water pump 261, the SPU 262, the PCU 263, the oil cooler 264, the water-cooled condenser 251, and the six-way valve 380 (port P32) in this order. A heat medium temperature sensor 266 is provided in the channel 260b. The channel 260b is an example of the second channel according to the aspect of the disclosure, and the PCU 263 and the oil cooler 264 are an example of the drive unit according to the aspect of the disclosure. The system including the PCU 263, the oil cooler 264, and the battery 272 is an example of the driving system according to the aspect of the disclosure.

The drive unit circuit 260 may include a transaxle instead of the oil cooler 264. In the drive unit circuit 260, heat may be exchanged between heat generated by supplying electric power to a stator without rotating a rotor of the motor and a heat medium flowing through the drive unit circuit 260.

The battery circuit 270 includes, for example, advanced driver-assistance systems (ADAS) 271, the battery 272, and a channel 270b. The channel 270b connects the six-way valve 380 (port P31), the ADAS 271, the battery 272, and the six-way valve 380 (port P34) in this order. The battery 272 is provided with a battery temperature sensor 273. The channel 270b is an example of the first channel according to the aspect of the disclosure.

The ADAS 271 include, for example, adaptive cruise control (ACC), auto speed limiter (ASL), lane keeping assist (LKA), pre-crash safety (PCS), and lane departure alert (LDA). The battery circuit 270 may include an autonomous driving system (ADS) in addition to the ADAS 271.

### Modes

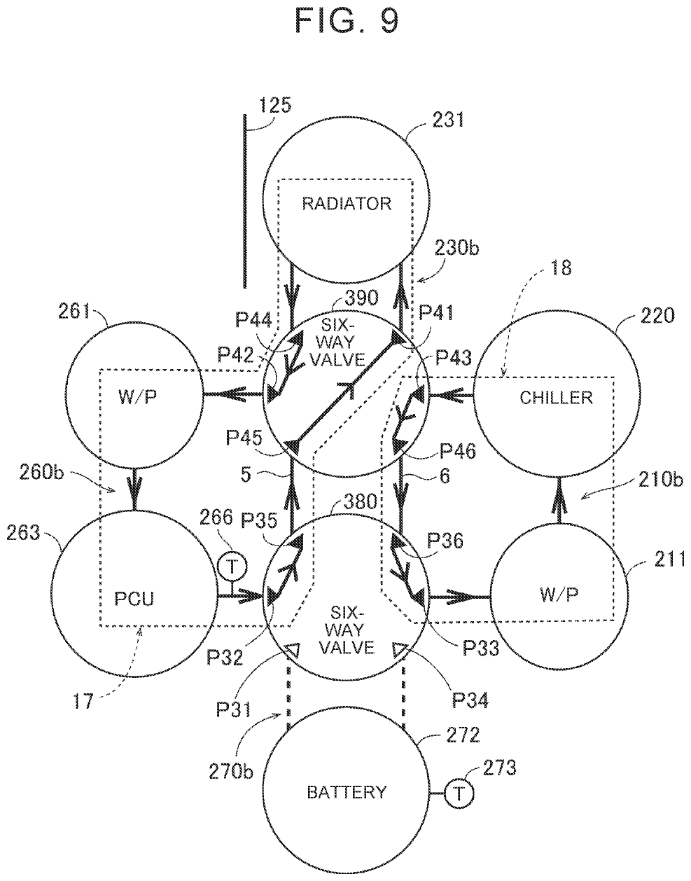

FIG. 9 is a conceptual view that shows the outline of a predetermined mode (hereinafter, which may be referred to as isolation mode) in the heat management circuit 300, established by controlling the six-way valve 380 and the six-way valve 390. Through control of the six-way valve 380 and the six-way valve 390, a connection status among the channels 210b, 230b, 260b, 270b is switched. Thus, the heat management circuit 300 is switched between a plurality of modes including the isolation mode.

In the present embodiment, when the battery 272 is heated, the ECU 500 controls the six-way valve 380 and the six-way valve 390 such that the isolation mode shown in FIG. 9 is established. Specifically, in the isolation mode, a route that communicates the port P32 with the port P35 and a route that communicates the port P33 with the port P36 are established by the six-way valve 380, and a route that communicates the port P41 with the port P45, a route that communicates the port P42 with the port P44, and a route that communicates the port P43 with the port P46 are established by the six-way valve 390.

As a result, a fourth closed circuit 17 (see FIG. 9) in which the channel 260b corresponding to the second channel, the coupling channel 5, and the channel 230b corresponding to the third channel are connected and a fifth closed circuit 18 (see FIG. 9) in which the channel 210b corresponding to the fourth channel and the coupling channel 6 are connected are established, and the channel 270b corresponding to the first channel is isolated from the other channels. In other words, the battery 272 is in a state of being isolated from the other circuits (independent state).

In the isolation mode shown in FIG. 9 as well, during heating control of the ECU 500, cooling of the battery 272 with a heat medium flowing through the fourth closed circuit 17 or the fifth closed circuit 18 is suppressed, and heat generated from the PCU 263 or the transaxle (not shown) is accumulated in the heat medium flowing through the fourth closed circuit 17.

As a result of these, it is possible to achieve both effective use of heat generated from the drive unit such as the PCU 263 and efficient self-heating of the battery 272.

### Control Method for Heat Management Circuit

Control details of the heat management system 3 according to the present embodiment are substantially the same as the control details of the first embodiment, so, hereinafter, only the difference from the control details of the first embodiment will be described.

In other words, in the present embodiment, in step S3, the ECU 500 controls the six-way valve 380 and the six-way valve 390 such that the heat management circuit 300 is in the isolation mode shown in FIG. 9, executes heating control of the battery 272, and drives the water pump 261 of the fourth closed circuit 17.

### Third Embodiment

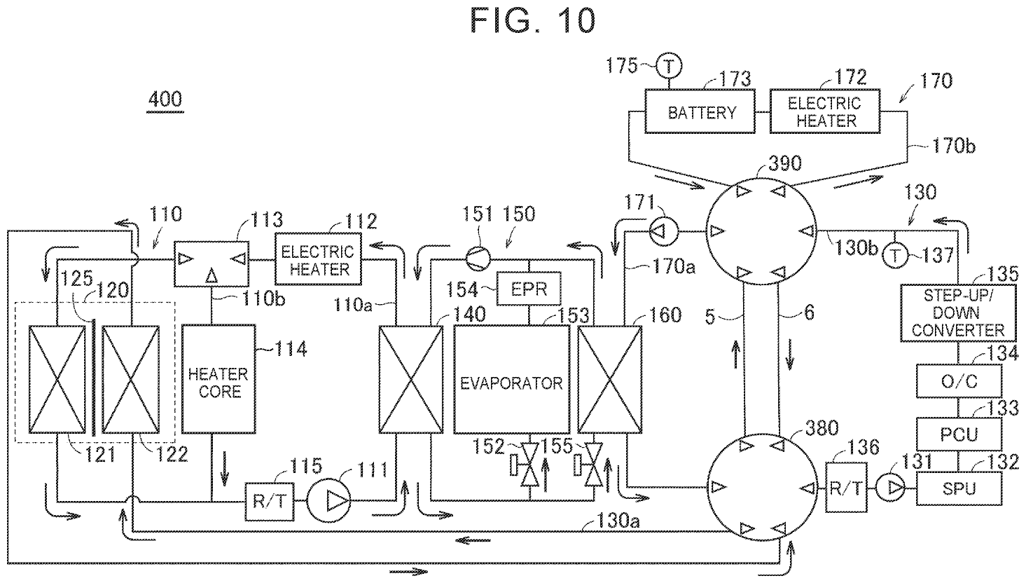

Next, a heat management circuit 400 according to a third embodiment of the disclosure will be described with reference to FIG. 10. In the third embodiment, only a portion different from the first embodiment will be described, and the description of the same structures, operations, and advantageous effects as those of the first embodiment will not be repeated.

### Overall Configuration

A heat management system (not shown) according to the present embodiment differs from the heat management system 1 (see FIG. 1) according to the first embodiment in that the heat management circuit 400 is provided instead of the heat management circuit 100.

The heat management circuit 400 differs from the heat management circuit 100 in that the six-way valve 380 and the six-way valve 390 are provided instead of the five-way valve 180 and the five-way valve 190. In other words, the heat management circuit 400 corresponds to the one in which the high-temperature circuit 110 according to the first embodiment is added to the heat management circuit 300 according to the second embodiment. The six-way valve 380 and the six-way valve 390 are an example of the switching unit according to the aspect of the disclosure.

The modes established in the heat management circuit 400 as a result of switching of the six-way valve 380 and the six-way valve 390 are the same as the modes described in the second embodiment.

In the first embodiment, an example in which the heat management circuit 100 includes the high-temperature circuit 110 has been described. In the heat management circuit 100, the high-temperature circuit 110 may be omitted.

In the above-described embodiments, an example in which heating control of the battery is executed when the electrified vehicle 1a starts driving (when the driving system starts up) has been described; however, timing at which heating control is started is not limited thereto. For example, heating control may be executed when the temperature of the battery becomes lower than a predetermined threshold (for example, 10° C.). In this case, the ECU may acquire a detected value of the temperature of the battery at intervals of a predetermined period (for example, one hour).

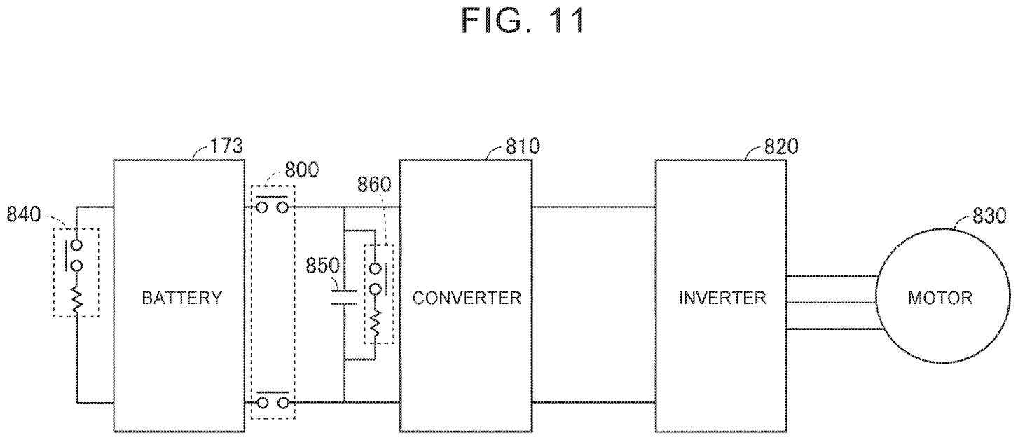

Here, heating control that is an example of a method of increasing the temperature of the battery 173 will be described with reference to FIG. 11. The battery 173 is connected to a converter 810 via a system main relay (SMR) 800. The converter 810 is connected to the inverter 820. The inverter 820 is connected to a motor 830. A discharge circuit 840 including a switch and a resistive element is connected to the battery 173. A smoothing capacitor 850 is provided between the battery 173 and the converter 810. A discharge circuit 860 made up of a switch and a resistive element is connected in parallel with the smoothing capacitor 850. FIG. 11 representatively shows the configuration of the first embodiment as a reference; however, the other embodiments may be similarly configured.

Heating control of the battery 173 may include, for example, control to electrically disconnect the SMR 800 and turn on the switch of the discharge circuit 840. Thus, a current flows through a closed circuit formed by the battery 173 and the discharge circuit 840. Heating control of the battery 173 may include control to turn off the switch of the discharge circuit 840 and turn on the SMR 800 and the switch of the discharge circuit 860. Thus, a current flows through a closed circuit formed by the battery 173, the SMR 800, and the discharge circuit 860. Heating control of the battery 173 may include control to turn on the SMR 800 and pass a current adjusted such that no torque is generated in the motor 830 in a state where the switch of the discharge circuit 840 and the switch of the discharge circuit 860 are off.

The above-described heating control is an example of a method of heating the battery 173 when the temperature of the battery 173 is lower than a reference temperature Tb. In each of the embodiments, timing at which the ECU 500 controls the switching unit (the five-way valves 180, 190 or the six-way valves 380, 390) such that a heating mode is established is not limited to the time during the heating control.

An entity that executes switching of the switching unit is not limited to the ECU 500 (controller) mounted on the electrified vehicle 1a. The switching unit may form a circuit in the heating mode based on, for example, a signal received from outside the electrified vehicle 1a.

Persons skilled in the art understand that the above-described illustrative embodiments are specific examples of the following aspects.

### Aspect 1

A heat management system provided in an electrical apparatus includes: a first channel, a second channel, a third channel, and a fourth channel configured such that a heat medium flows through the first channel, the second channel, the third channel, and the fourth channel; an electrical storage device configured to exchange heat with the heat medium flowing through the first channel; a drive unit configured to exchange heat with the heat medium flowing through the second channel and supply driving force to the electrical apparatus; a radiator provided in the third channel; a chiller provided in the fourth channel; and a switching unit configured to switch a connection status among the first channel, the second channel, the third channel, and the fourth channel, and the switching unit is configured to, when the electrical storage device is heated, isolate the first channel from the other channels, form a circuit with which the heat medium circulates through the second channel and the third channel, and form a circuit with which the heat medium circulates through only the fourth channel.

With the heat management system, when the electrical storage device is heated, cooling of the electrical storage device with a heat medium flowing through the second channel and the third channel or a heat medium flowing through the fourth channel is suppressed, and heat generated from the drive unit is effectively accumulated in the heat medium flowing through the second channel and the third channel. Thus, it is possible to achieve both effective use of heat generated from the drive unit and efficient heating of the electrical storage device.

### Aspect 2

The heat management system according to the aspect 1 further includes a grille shutter configured to, when the electrical storage device is heated, adjust a volume of air heading toward the radiator by adjusting an opening degree of the grille shutter, and the grille shutter is configured to, when the electrical storage device is heated, increase the opening degree when a temperature of the heat medium flowing through the second channel and the third channel or a temperature of the drive unit becomes higher than a prescribed temperature.

With this aspect, the temperature of a heat medium flowing through the second channel and the third channel decreases when the opening degree of the grille shutter is increased, so the drive unit is effectively cooled.

The embodiments described above are illustrative and not restrictive in all respects. The scope of the disclosure is not defined by the description of the above-described embodiments, and is defined by the appended claims. The scope of the disclosure is intended to encompass all modifications within the scope of the appended claims and equivalents thereof.

What is claimed is:

1. A heat management system provided in an electrical apparatus, the heat management system comprising:
a first channel, a second channel, a third channel, and a fourth channel configured such that a heat medium flows through the first channel, the second channel, the third channel, and the fourth channel;
an electrical storage device configured to exchange heat with the heat medium flowing through the first channel;
a drive unit configured to exchange heat with the heat medium flowing through the second channel and supply driving force to the electrical apparatus;
a radiator provided in the third channel;
a chiller provided in the fourth channel; and
a switching unit configured to switch a connection status among the first channel, the second channel, the third channel, and the fourth channel, wherein the switching unit is configured to, when the electrical storage device is heated, isolate the first channel from the other channels, cause a circuit with which the heat medium circulates through the second channel and the third channel to be formed, and cause a circuit with which the heat medium circulates through only the fourth channel to be formed.

2. The heat management system according to claim 1, further comprising a grille shutter configured to adjust a volume of air heading toward the radiator by adjusting an opening degree of the grille shutter, wherein the grille shutter is configured to, when the electrical storage device is heated, increase the opening degree when a temperature of the heat medium flowing through the second channel and the third channel or a temperature of the drive unit becomes higher than a prescribed temperature.

3. The heat management system according to claim 1, wherein the switching unit is a five-way valve or a six-way valve.
